(19) United States
(12) Patent Application Publication
(10) Pub. No.: US 2021/0029901 A1
(43) Pub. Date: Feb. 4, 2021

(54) Plant System with Water Storage Chambers

(71) Applicant: CMI LLC, Providence, RI (US)

(72) Inventor: Paul Anthony IORIO, Pawtucket, FL (US)

(21) Appl. No.: 17/045,993

(22) PCT Filed: Apr. 8, 2019
(86) PCT No.: PCT/US2019/026397

§ 371 Date: Oct. 8, 2020

Related U.S. Application Data
(60) Provisional application No. 62/654,502, filed on Apr. 8, 2018.

(51) Int. Cl. A01G 27/02; A01G 25/06; A01G 29/00; E01C 9/00

(52) U.S. Cl. CPC A01G 27/02; E01C 9/005; A01G 29/00; A01G 25/06

(57) ABSTRACT

A plant system with structural frame and water storage chamber which allows for the collection of surface water emanating from impervious surface for retrieval and re-use.

### BACKGROUND OF THE INVENTION

The present invention is intended to be a pre-fabricated structural frame combined with a separate water collection and storage chamber to provide a reservoir of water from which to draw from when supplemental irrigation is required to support healthy plant growth during periods of drought or environmental stress. More particularly, the invention is intended to allow for the flexibility in utilizing multiple shapes and dimensions of both the structural frame and separate water storage chamber.

Previously patented manufactured underground water storage chambers exist; however, they are typically used for the detention of collected stormwater, and not for storage and re-use such as for supplemental irrigation, or in combination with a structural frame to support plant systems. Furthermore, the pre-fabricated frame is envisioned to be a stand-alone structure of various design that is solely intended to be set in place prior to the pouring of concrete such as in sidewalk construction.

The ability to capture and store stormwater during times of surplus and having the ability to retrieve or withdraw this stored water during times of drought, would be of great benefit in promoting sustained and healthy plant growth, particularly in highly impervious situations. The ability to manage and provide sufficient irrigation as necessary is also of particular importance in regions where rainfall intensity and frequency are minimal and/or inconsistent.

### BRIEF DESCRIPTION OF THE INVENTION

The present invention is directed to a tree frame and grate system designed to encourage healthy and abundant root growth as well as permitting optimal development and growth of vegetation within an urban landscape. Specifically, the present invention relates generally to a plant system within a sidewalk or street planting application with the ability to collect, detain, retain or otherwise store incoming storm water in a subsurface chamber. More specifically, the present invention is designed to make available this captured storm water for retrieval and dispersal as a form of supplemental irrigation to overlying plant systems as necessary. The system is designed to encourage the collection and retention of rainwater, particularly in an arid environment, to provide continuous irrigation of vegetation. The system is also designed to maximize the amount of water available to vegetation in a primarily paved environment. The present invention is intended to be a combined tree frame and grate system, with a water collection and storage system, whereby plant material such as trees can better survive and thrive in a primarily impervious surface environment. More particularly, the invention is intended to allow for the flexibility in utilizing multiple shapes and dimensions of manufactured tree grates.

### BRIEF DESCRIPTION OF THE DRAWINGS

FIG. 1 is a cutaway cross section view of a plant system with water storage chamber of the present invention;

FIG. 2 is a plan view of a plant system with water storage chamber of the present invention;

FIG. 3 is a cutaway cross section view of a second embodiment of the plant system with water storage chamber of the present invention;

FIG. 4 is a plan view of a second embodiment of the plant system with water storage chamber of the present invention;

FIG. 5 is a plan view of a plant system with water storage chamber of the present invention in series or multiple units;

FIG. 6 is a plan view of a third embodiment of the plant system with water storage chamber not in proximity to street or curb.

These renderings and images are included for illustrative and interpretive purposes relative to specific embodiments and applications and should not be construed as the sole positioning, configurations, or singular use of the present invention.

### DETAILED DESCRIPTION OF THE INVENTION

### Definitions

The following terms are defined to aid the reader in fully understanding the operation, function, and utility of the present invention.

“±5%” as used herein, refers to the possibility that the stated amount may vary by 5%. For instance, 100±5%, indicates that the claimed value may range from 95 to 105.

“And/or” as used herein, refers to the possibility that both items or one or the other are claimed. For instance, A and/or B refers to the possibility of A only, B only or both A and B are present in the claimed invention.

“Aggregate” as used herein, refers to a sum, mass, or assemblage of various loose particles of inorganic and/or organic matter of various size and dimension. Furthermore, an “aggregate matrix layer” would represent a distinct or discreet layer of the sum of one or more aggregates.

“ASTM” as used herein, refers to American Society for Testing Materials.

“Bioavailable” as used herein, refers to the extent to which a nutrient or other substance is taken up by a plant's root system to be metabolized and therefore provide growth enhancement to the plant, (e.g., nitrogen, phosphorus, fertilizer, etc.).

“Bulk density” as used herein, is the weight of aggregates in a given volume. Aggregates with greater bulk densities tend to restrict root growth when compacted, particularly in greater concentrations of finer particles are present.

“Canopy” as used herein with respect to trees, refers to the extent of the outer layer of leaves of an individual tree or group of trees.

“Engineered media” as used herein, refers to a growing media specifically formulated, blended, and designed to provide enhanced growing characteristics such as moisture and oxygen retention, nutrient sorption, infiltration capacity, and other attributes to enable the plant material to reach its fullest potential for establishment and growth.

“Impervious/impermeable” as used herein, collectively are terms to describe surfaces that are mainly artificial structures—such as pavements (roads, sidewalks, driveways and parking lots) that are covered by impenetrable materials such as asphalt, concrete, brick, stone. Compacted soils may also be termed, impervious or impermeable.

“Impermeable subsurface membrane liner” as used herein, refers to a synthetic, flexible material which acts as a barrier to separate and maintain segregation between two discrete layers of inorganic and/or organic materials thus preventing the infiltration of water between the two layers.

“Notch” as used herein, is a slightly lower level or recessed surface within the top sidewall of the frame of the present invention which allows for the setting and support of a grate or plate while maintaining equal elevation of both the top surface of the grate or plate and the surface of the top sidewall.

“Porosity” as used herein, refers to the quantity of pores, or open space between aggregate particles. Pore spaces may be a function of the size and shape of various aggregate particles, and how they integrate or connect as a mass, or can be formed or expanded due to the movement of roots. The differences in the size and shape of the aggregates influence the way they fit together, and thus their porosity.

“Plants” or “vegetation” as used herein, is a collective term for a living organism of the kind exemplified by trees, shrubs, herbs, grasses, ferns, and mosses, typically growing in a permanent site, absorbing water, oxygen, and nutrients through its roots.

“Semi-impermeable subsurface membrane liner” as used herein, refers to a synthetic, flexible material which acts as a porous barrier to separate and maintain segregation between two discrete layers of inorganic and/or organic materials thus allowing for the controlled flow of water between the two layers.

“Sorption” as used herein, is a collective term for both absorption and adsorption considered as a single process.

“Streetscape” as used herein, refers to the visual elements of a street, including the road, adjoining buildings, sidewalks, street furniture, trees and open spaces, etc., that combine to form the street's character.

“Sump” as used herein, refers to a pit or hollow in which liquid collects.

“Tree pit” as used herein, refers to the hole in the ground in which a tree is planted. In the urban context, the pit may represent the areal dimension of open non-impervious space within an otherwise impervious pavement surface.

“Urban” as used herein, relates to, or is characteristic of a city or town particularly that where the ground surface is primarily paved and impervious.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

Also, use of the “a” or “an” are employed to describe elements and components of the invention. This is done merely for convenience and to give a general sense of the invention. This description should be read to include one or at least one and the singular also includes the plural unless it is obvious that it is meant otherwise.

Reference throughout this specification to “plant(s)”, “tree(s)”, “vegetation”, or “roots” is used. One skilled in the art will recognize that embodiments of the invention should not be limited to these terms and that the terms herein are interchangeable or in general association for any tree, plant, root, or other vegetation that would benefit from the described invention.

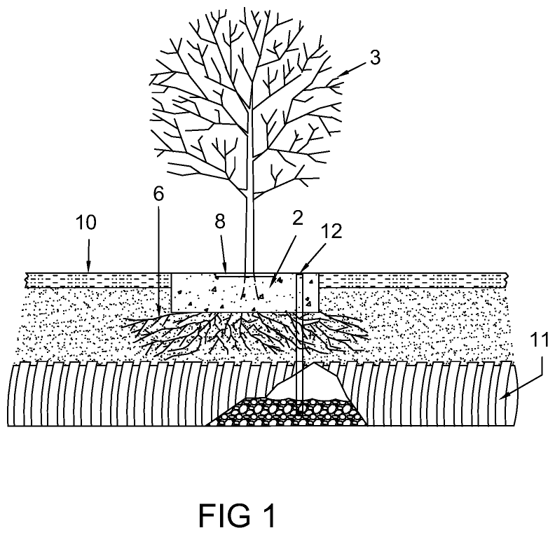

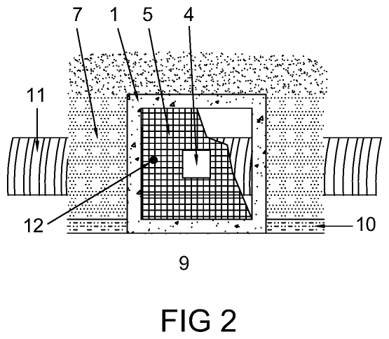

Referring now to the invention in more detail, in FIG. 1 and FIG. 2 there is shown a structural plant system with a water storage chamber comprised of an open-bottomed frame of varying shapes and dimensions with a top 1 at least partially open to the atmosphere, and with one or more side walls 2 of varying vertical dimension. Plant material 3 will be located within the container with vegetative growth emanating through one or more openings 4 in the top portion of the frame of varying dimensions, a portion of which may be enclosed with a polymer or metal-based fabricated grate or plate 5 with at least partial or free expression of the tree's attended root system 6 beyond the exterior “footprint” of the frame. The frame is envisioned to be located within a primarily impervious pedestrian walking surface or paved area such as a sidewalk 7 or the like.

An embodiment of the invention would be that a “throat” or opening 8 is positioned within one side of the frame that is in close proximity and/or in communication with a primarily impervious surface such as a street 9 so as to allow rain water runoff from the street to enter the interior portion of the frame and to be dispersed. This side with the opening may adjoin or integrate with street curbing 10.

The construction details of the invention as shown in FIG. 1 and FIG. 2 are that the frame may be configured in various shapes and dimensions and made of concrete or of any other sufficiently rigid and strong material such as a polymer, metal, and the like.

Continuing with FIG. 1 and FIG. 2, the present invention would include a water holding chamber 11 positioned below the frame which is intended to collect, detain or retain infiltrating water emanating from the interior of the frame and/or from locations exterior of the frame, originating from precipitation events. It is envisioned that the chamber could have perforations or otherwise maintain one or more openings along its walls to allow for the collection of infiltrating water emanating from the overlying and/or surrounding soil. Alternatively, the chamber could be impermeable or primarily impermeable along its walls. It is envisioned that a length of pipe 12 would connect to or otherwise interface with the chamber. One purpose of the pipe would be to allow for the retrieval of water from the chamber from a position at or near the ground surface. Additionally, or alternatively, the pipe could function as a collection port for accumulating water within the plant frame to be conveyed to the chamber. The pipe and chamber may be configured in various shapes and dimensions and made or composed of a sufficiently rigid and strong material such as a polymer, metal, concrete, or the like.

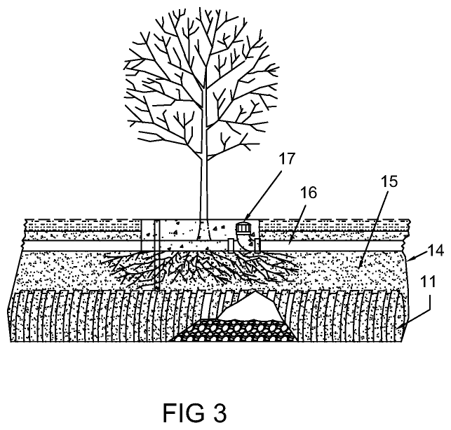

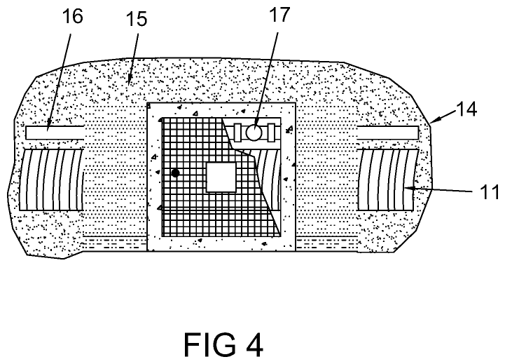

Referring now to FIG. 3 and FIG. 4, an embodiment of the invention would be that an impervious or semi-impervious liner 14 would surround the present invention either partially or entirely, and may or may not include the chamber 11, as well as quantities of surrounding soils 15.

An additional embodiment would be the inclusion of a pipe 16 and fitting(s) assembly horizontally traversing the subsurface with a collection point 17. The intent of this embodiment would be to collect incoming surficial water that collects within the interior of the frame with the ability to conduct and distribute the water laterally to additional plant frames and/or surrounding soils. The pipe may or may not contain perforations. The pipe and chamber may be configured in various shapes and dimensions and made or composed of a sufficiently rigid and strong material such as a polymer, metal, concrete, or the like.

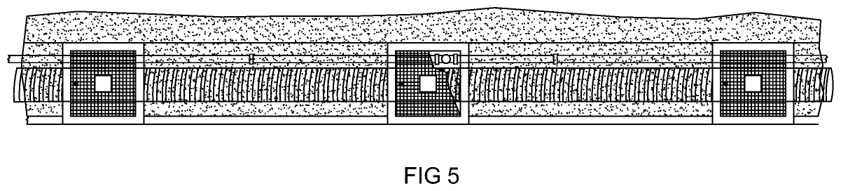

Referring now to FIG. 5, it is envisioned that one or more plant systems may be connected in series. Additionally, one or more of the aforementioned embodiments as described in FIGS. 1-4 may be included and/or connected within the series.

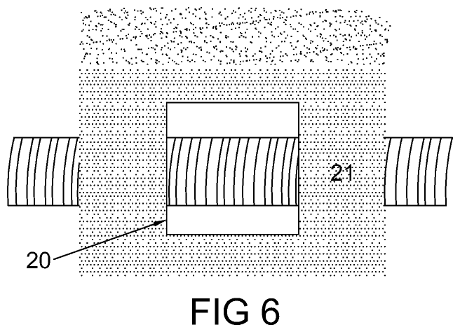

Referring now to FIG. 6, an additional embodiment of the present invention would be that the structural frame would not be integrated or otherwise in close proximity with a street and/or curbing. In this embodiment, water would enter the top portion of the frame 20 from the surrounding impervious surface 21.

The advantages of the present invention and embodiments include, without limitation, the ability to collect water emanating from impervious surfaces occurring from precipitation events which enter a plant frame, with the capacity to detain or retain this water for retrieval and distribution during periods of drought or as required. An additional advantage of the current invention would be that the frame could be fabricated and manufactured to accommodate virtually limitless numbers of shapes, dimensions, and styles of grating or plating.

In the above description, numerous specific details are provided, such as the identification of various system components, to provide an understanding of embodiments of the invention. One skilled in the art will recognize, however, that embodiments of the invention can be practiced without one or more of the specific details, or with other methods, components, materials, etc. In still other instances, well-known structures, materials, or operations are not shown or described in detail to avoid obscuring aspects of various embodiments of the invention. Reference throughout this specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more embodiments.

The descriptions and drawings should be assumed as illustrative only of the principles of the invention. The invention may be configured in a variety of shapes and sizes and is not limited by the aforementioned dimensions, construction and operation of the identified parts, materials or embodiments. It is understood that numerous modifications, changes, and substitutions of the invention will readily occur to those skilled in the art and may be resorted to falling within the scope and spirit of the invention.

While the previous description contains many specifics, these should not be construed as limitations on the scope of the invention, but as exemplifications of the presently preferred embodiments thereof. Thus, the scope of the invention should be determined by the appended claims and their legal equivalents. It is not desired to be limited to the exact details of construction shown and described for obvious modifications will occur to a person skilled in the art, without departing from the spirit and scope of the appended claims.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

I claim:

1. A plant frame system comprising
an open-bottomed frame comprising four walls and a partially-opened top wall capable of allowing vegetation to grow outward thereof and said vegetation's attended root system extends downward beyond the bottom edge of said frame; and
a water collection and storage system.

2. The plant frame system according to claim 1, wherein said water collection and storage system is separate from said open-bottomed frame.

3. The plant frame system according to claim 1, wherein said water collection and storage system irrigates vegetation planted in said open-bottomed frame.

4. The plant frame system according to claim 1, further comprising a grate or plate.

5. The plant frame system according to claim 4, wherein said grate or plate is a polymer or metal-based fabricated grate or plate.

6. The plant frame system according to claim 5, wherein said grate or plate partially exposes the interior of the system to the atmosphere;
wherein when vegetation is planted within said system and said grate or plate is installed, said vegetation can grow upward vertically out of said system.

7. The plant frame system according to claim 1, wherein said vegetation is a tree.

8. The plant frame system according to claim 1, wherein said frame is comprised of a rigid and strong material.

9. The plant frame system according to claim 8, wherein said material is a polymer, metal or concrete.

10. The plant frame system according to claim 9, wherein said material is concrete.

11. The plant frame system according to claim 1, wherein said plant frame system is installed into a pedestrian walking surface or paved area.

12. The plant frame system according to claim 1, wherein said plant frame system is installed adjacent to a pedestrian walking surface or paved area.

13. The plant frame system according to claim 11, wherein said walking surface is a sidewalk.

14. The plant frame system according to claim 12, further comprising an opening that is in close proximity to an impervious surface wherein said opening allows rain water to enter said plant frame system.

15. The plant frame system according to claim 14, wherein said opening is integrated or situated next to a curb of a road or street.

16. The plant frame system according to claim 12, wherein said paved area is a road or street.

17. The plant frame system according to claim 1, wherein said system is circular in shape.

18. The plant frame system according to claim 2, wherein said grate or plate covers the entire top surface of said plant frame system.

19. The plant frame system according to claim 2, wherein said plant frame system further comprises a notch, supporting beams affixed to the interior of the frame or lateral cross members.

20. The plant frame system according to claim 19, wherein said grate or said plate is positioned in said notch or upon said supporting beams or lateral cross members.

21. The plant frame system according to claim 20, wherein said grate or plate is even with the top surface of said frame wherein when said grate or plate is installed in said notch, said plate and said frame create a flat, even surface.

22. The plant frame system according to claim 2, further comprising a recess in the top of said frame wherein said recess may be fitted with pavers, step stones, gravel or decorative material wherein when said pavers, step stones, gravel or decorative material is installed an even, level surface is created with the grate or plate, frame and surrounding area.

23. The plant frame system according to claim 1, further comprising a growing media comprising a mixture of or discreet layers of both organic and inorganic growing material.

24. The plant frame system according to claim 23, wherein said media is engineered and blended in proportions that would support the adjoining pavement.

25. The plant frame system according to claim 23, wherein said media forms a sump.

26. The plant frame system according to claim 25, wherein said sump collects rainwater emanating from the surrounding surface pavement; wherein said collected rainwater irrigates the vegetation planted in said system.

27. The plant frame and grating system according to claim 23, wherein said growing media stores oxygen; wherein said stored oxygen promotes vegetation growth in said system.

28. The plant frame system according to claim 23, wherein said growing media is contained entirely in said system.

29. The plant frame system according to claim 23, wherein said growing material extends beyond the bottom edges of the system into the surrounding environment.

30. The plant frame system according to claim 1, further comprising electrical outlets.

31. The plant frame system according to claim 30, further comprising a first waterproof conduit embedded into the frame of the system through the interior of said system containing said electrical outlets.

32. The plant frame system according to claim 30, wherein said conduit extends upward from the interior of the system and is accessible to a user once the system is installed.

33. The plant frame system according to claim 32, further comprising a means by which to secure the accessible electrical outlets.

34. The plant frame system according to claim 32, wherein said means is a lock box.

35. The plant frame system according to claim 30, wherein said electrical outlets provide power to said system so that decorative and/or aesthetically-pleasing devices may be incorporated into said system and/or onto vegetation planted in said system.

36. The plant frame system according to claim 30, wherein said electrical outlets provide power to spot lights directed onto the vegetation growing out of the system.

37. The plant frame system according to claim 31, comprising a second waterproof conduit that is connected to said first waterproof conduit and that extends out from said system to a remote power source.

38. The plant frame system according to claim 1, further comprising tubing or piping embedded into the frame of said system and extending outward from said system to a remote water supply;
wherein said tubing or piping provides supplemental irrigation to the vegetation planted in said system.

39. The plant frame system according to claim 1, wherein said system is designed to allow the roots of plants to be contained within the system and then be re-directed outwards from the bottom edges of the system both horizontally and vertically from said bottom edges of the system into the surrounding environment; wherein said roots of plants are prevented from growing upwards towards the surrounding surface pavement.

40. The plant frame system according to claim 1, further comprising an impermeable, subsurface membrane liner.

41. The plant frame system according to claim 40, wherein said liner is manufactured from a material selected from the group consisting of rubber, polyethylene, a synthetic material, or a combination thereof.

42. The plant frame system according to claim 40, wherein said liner surrounds part of the system.

43. The plant frame system according to claim 42, wherein said liner surrounds at least 25-95% of the system.

44. The plant frame system according to claim 40, further comprising one or more inlet and outlet pipes that traverse said liner.

45. The plant frame system according to claim 40, wherein said liner extends beyond one or more vertical sidewalls of the system into the surrounding soil.

46. The plant frame system according to claim 1, further comprising a semi-impermeable, subsurface membrane liner.

47. The plant frame system according to claim 46, wherein said liner is manufactured from a material selected from the group consisting of rubber, polyethylene, a synthetic material, or a combination thereof.

48. The plant frame system according to claim 46, wherein said liner surrounds part of the system.

49. The plant frame system according to claim 48, wherein said liner surrounds at least 25-95% of the system.

50. The plant frame system according to claim 46, further comprising one or more inlet and outlet pipes that traverse said liner.

51. The plant frame system according to claim 46, wherein said liner extends beyond one or more vertical sidewalls of the system into the surrounding soil.

52. The plant frame system according to claim 1, wherein said system is pre-fabricated prior to installation.
